(19) United States
(12) Patent Application Publication
(10) Pub. No.: US 2008/0012958 A1
(43) Pub. Date: Jan. 17, 2008

(54) White balance system and the method thereof

(75) Inventors: Kuan-Yi Wu, Sanchong City (TW); Houng-Jyh Wang, Taipei City (TW)

Correspondence Address: RABIN & Berdo, PC, 1101 14TH STREET, NW, SUITE 500, WASHINGTON, DC, 20005, US

(73) Assignee: TECO ELECTRIC & MACHINERY CO., LTD., Taipei (TW)

(21) Appl. No.: 11/729,849

(22) Filed: Mar. 30, 2007

(30) Foreign Application Priority Data
Jul. 11, 2006 (TW) 095125316

(51) Int. Cl. H04N 9/73

(52) U.S. Cl. 348/223.1

(57) ABSTRACT

Disclosed is a white balance method and system thereof. The system contains a process range unit, a difference gain unit, a white balance core unit, and a constraint unit. The method thereof is that selecting at least one gray pixel by the process range unit and the difference gain unit. Then, the first mean value and the second mean value are obtained according to the gray pixel by the core of the white balance unit. Subsequently, the correctional color value is calculated based on the second mean value. Finally, the constraint unit may perform a constraint operation on the correctional color value if needed.

### RELATED APPLICATIONS

This application claims priority to Taiwan Application Serial Number 95125316, filed Jul. 11, 2006, which is herein incorporated by reference.

### BACKGROUND

1. Field of Invention

The present invention relates to a method and a system of white balance. More particularly, the present invention relates to a method and a system of white balance by processing a single gray pixel.

2. Description of Related Art

In the real world, the color of objects changes because the light that is illuminating them changes. The human eyes and brain can adjust the color that the human sees automatically. However, image-capturing devices record the color of objects with no adjustment. Therefore, to create an image that accurately depicts what the human intended to see, image-capturing devices must make adjustments when necessary, and the techniques of dealing with adjustments are referred to as white balance.

White balance technology adjusts the color value of the pixels, and corrects the color of the image to depict accurately what is intended for the human to see. Therefore, the application of white balance technology is very popular. The digital camera and the digital video camera always have several white balance modes and/or manual modes for different illuminating situation.

White balance technology on the display apparatus (such as LCD TV, PDP TV) is different from the image capture device, but it is also crucial to improve the image quality. The signals of the display apparatus are the TV signal and movie signal. Either the TV system provider or the movie provider processes these signals.

Due to differences between specific display apparatus and the difference between cultures, people have a variety of color definitions. However, white is a color that has a single standard color tone. White means pure in the cognition of people. People can easily differentiate other impurities from white color. Intensifying the white color of the image enables users to get a better impression of the displayed scene. The white balance of the display apparatus always corrects the white region of the image to enhance the effect of the scene due to the reason described above. The audio/video post-processing unit of the display apparatus enhances the other colors.

Conventional white balance correction steps include searching for white/gray pixels in the whole image, performing a logical operation to obtain a correction value, and then adjusting the whole image based on the correction value. The conventional white balance correction needs greater and complicated operations, and needs a large amount of memory space to store the information of the image and the parameters. The searching process on the whole image needs a lot of time. Moreover, the great and complicated operation increases the loading of the IC chip. If the white balance system realizes in the silicon solution, the great and complicated operation functions will increase the area of the IC and the cost. Therefore, many improved white balance correction methods are provided.

Although the white balance methods are improving with the technology, there is still room for improvement. The objectives of the current white balance system and method thereof includes increasing the speed of the processes, reducing the complexity of the algorithms to decrease the size of the IC chip and increase the programming convenience, and reducing the usage space of the memory and register to decrease the overall cost.

### SUMMARY

The current embodiment describes the white balance method comprising the steps of receiving a gray pixel color value of the digital image, and processing the color value to obtain a first mean value. Subsequently, obtaining three differences between the maximum color value, the medium color value, the minimum color value and the first mean value, and averaging out these three differences to obtain a second mean value. Finally, adjusting the color value of the gray pixel based on the second mean value to obtain the correctional color value of the gray pixel.

A white balance system comprises a process range unit, a difference gain unit, a white balance core unit, and a constraint unit. The process range unit and the difference gain unit are capable of selecting at least one gray pixel from a digital image. The white balance core unit is capable of processing a color value to obtain a correctional color value of the gray pixel. The constraint unit performs a constraint operation on the correctional color value. Moreover, the system further comprises a limiter unit for mending the correctional color value.

The process range unit and the difference gain unit analyze the color value of each pixel in the digital image, and select the gray points. The core of white balance and the constraint unit process correct the color value of each gray point and outputs the correctional color value.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram of a white balance system architecture of the embodiment of the present invention;

FIG. 2 is a schematic diagram of a flow chart of whit balance algorithm of the embodiment of the present invention;

FIG. 3 is a schematic diagram of a white balance method flow chart of the embodiment of the present invention;

FIG. 4 is a schematic diagram of a core of white balance system architecture of the embodiment of the present invention;

FIG. 5 is a schematic diagram of architecture which applies the white balance system of the embodiment of the present invention to a display apparatus;

FIG. 6 is a schematic diagram of architecture which applies the white balance system of the embodiment of the present invention to a digital camera and a digital video camera.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The following provides a detailed description of a method and a system for performing the white balance on a digital image. Each pixel has a relative color value. Every color value has three individual values are R, G, and B in the embodiment of the present invention. However, the system processes the color value based on the magnitude of the individual values of the color value, therefore, the individual values of the color value are called maximum color value, minimum color value, and medium color value herein. Also, the correctional color value has individual values as the maximum correctional color value, the minimum correctional color value, and the medium color value.

When the system of the embodiment decides a gray pixel needed to be corrected, then the system performs the white balance process on the single gray pixel, and outputs the correctional gray pixel. The white balance core algorithm is therefore very simple, the processing speed is very fast, and the usage of the memory and register is smaller. Someone skilled in the art could change the application for other situations, and modify the parameters of the system and the method for a variety of designs.

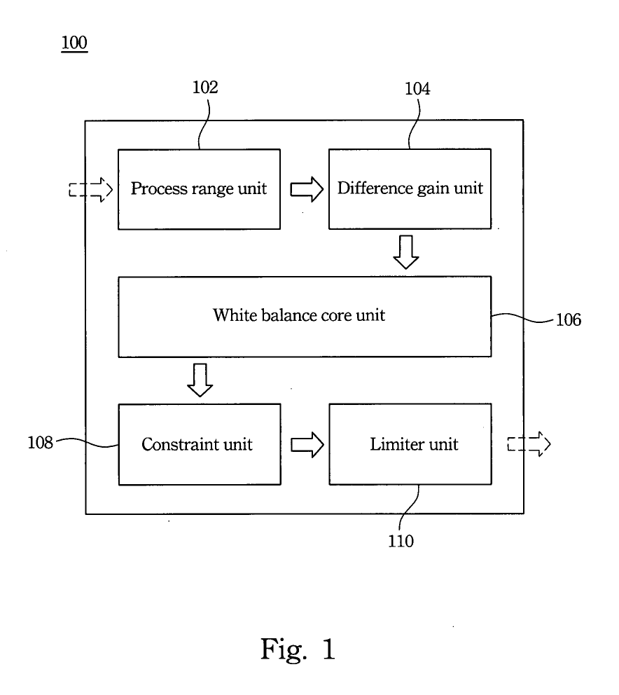

Please refer to FIG. 1. FIG. 1 is a schematic diagram of an white balance system architecture of the embodiment of the present invention. The white balance system architecture 100 comprises a process range unit 102, a difference gain unit 104, a white balance core unit 106, and a constraint unit 108. The process range unit 102 has a predefined color value range to select at least one first pixel from the digital image. The difference gain unit 104 is capable of determining at least one gray pixel from the first pixels. The white balance core unit 106 processes a color value of the gray pixel, then obtains the correctional color value of the gray pixel. The constraint unit is capable of performing a constraint operation on the correctional color value.

The correctional color value is obtained from performing a correctional operation on a second mean value with the color value by the core of white balance unit 106. The second mean value is obtained from averaging out the color value of the gray pixel to get a first mean value, and obtaining three differences between the maximum color value, the medium color value, the minimum color value and the first mean value, then averaging out of these three differences as the second mean value.

The three correctional operations categories are; maximum color value preservation, medium color value preservation, and the minimum color value preservation in each correctional operation, and then performing a calculation on the other two remaining color values with the second mean value.

Due to the constraint operations related to the correctional operations, there are also three constraint operations categories based on the maximum correctional color value, the medium color value, and the minimum color value in each constraint operation, and processing the other two remaining correctional color value. The constraint operations will be detail described in one embodiment.

The process range unit 102 and the difference gain unit 104 can be set in the off-state or in the on-state separately. The process range unit 102 and the difference gain unit 104 have a variety of selecting and determining manners depend on the input parameters in on-state.

Moreover, the constrain unit 108 can be also set in the off-state or in the on-state and has a variety of constraint mode depend on the input parameters in the on-state.

The system further comprises a limiter unit 110. The limiter unit 110 is capable of emending the correctional color value when the correctional color value is unpredictable abnormal. Of course, the limiter unit 110 can be also set in the off-state or in the on-state, and the constraint unit 108 has a variety of correcting modes depending on the input parameters in the on-state.

Therefore, the white balance system architecture 100 comprises several processing units 102, 104, 106, 108, and 110 described above. The processing units 102, 104, 108,110 can be separately set in the off-state or in the on-state, except the white balance core unit 106. There are a variety of selecting and determining methods and constraint and correcting modes that depend on the input parameters separately in the on-state. The processing units 102, 104, 108, 110 and the white balance core unit 106 cooperate to achieve the white balance objective.

For a more detail description of the white balance method and the function of the units in the system, an embodiment is described below. The system selects a gray pixel which is white mixed with other colors, and performs the white balance operation on the gray pixel to remove the composition of other colors.

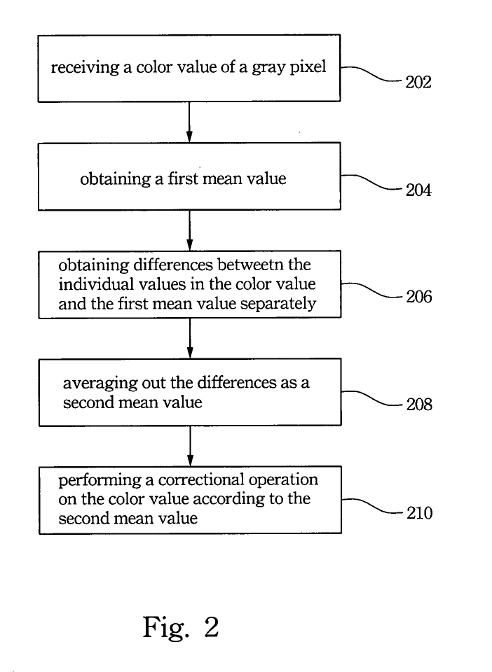

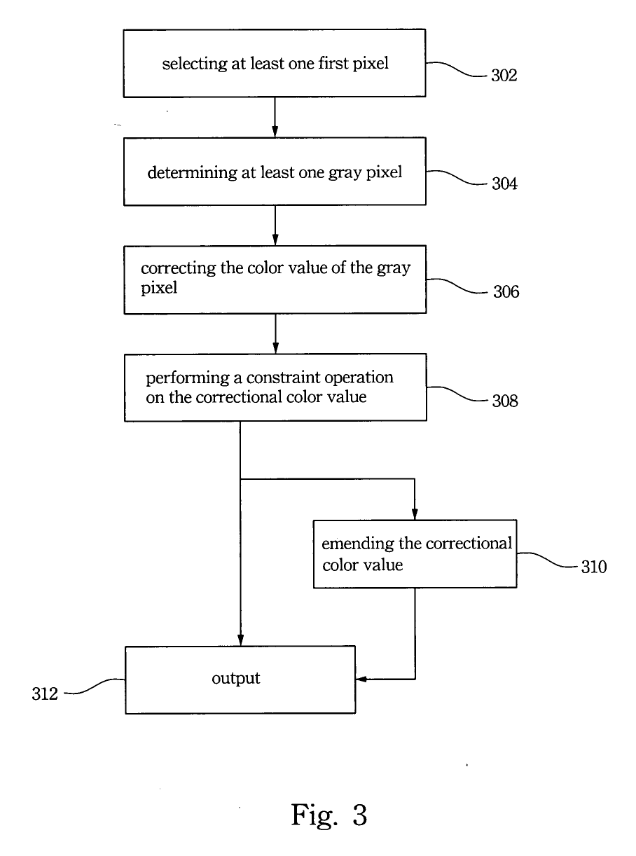

Please refer to FIG. 1, FIG. 2, and FIG. 3 together. FIG. 2 is a schematic diagram of a flow chart of a white balance algorithm of the embodiment of the present invention. FIG. 3 is a schematic diagram of a white balance method flow chart of the embodiment of the present invention.

The steps shown in FIG. 2 are the process of the white balance algorithm for correcting the gray pixel. The white balance core unit 106 in FIG. 1 performs the processes outlined in FIG. 2. In step 202, the color value is received by the white balance core unit 106. In step 204, the first mean value is obtained by averaging out the color value. In step 206, three differences between the maximum color value, the medium color value, the minimum color value and the first mean value are obtained. In step 208, the second mean value is obtained by averaging out these three differences. In step 210, the correctional color value is obtained by performing the correctional operation on the second mean value with the original color value.

The R, G, and B value of the color value are equivalent to each other in pure white. Therefore, in order to achieve the equivalence of the R, G, and B value, the correctional operation preserves the medium color value and subtracts the second mean value from the maximum color value, adds the second mean value to the minimum color value, in step 210. In other embodiments, the correctional operation could preserve the maximum color value or the minimum color value. Moreover, for a better correction result of the correction, the correctional operation can perform more complex functions, not only subtraction and addition.

After the function of the white balance core unit 106, that is the core architecture of the embodiment has been described above, please refer to FIG. 3. In the steps of FIG. 3, all units 102, 104, 108, and 110 are set in the on-state to describe the effect of the units 102, 104, 108, and 110 in the embodiment of the invention.

In step 302, the process range unit 102 analyses the pixel color value and selects a first pixel from the digital image, that is, the process range unit 102 filters the pixel color value from the digital image. Due to this embodiment focusing on the white color, the pixel color value has to reach a certain filter value for the pixel to be selected as the first pixel. The amount of the first pixel selection depends on the filter value, therefore, the filter value could be changed in another embodiment. Furthermore, the filter value can also be a filter range for selecting the first pixel more precisely.

In step 304, the difference gain unit 104 determines the gray pixel from the first pixels, that is, the difference gain unit 104 determines whether or not the first pixel is the gray pixel for white balance system. Due to this embodiment focusing on the white color, the difference gain unit 104 has a predetermined value to determine the gray pixel. If the minimum color value of the first pixel subtracts from the maximum color value of the first pixel below the predetermined value, then the first pixel is determined as the gray pixel for the white balance system. The amount of gray pixel determination depends on the predetermined value, therefore, the predetermined value could be changed in other embodiment for variant situations.

In step 306, the color value of the determined gray pixel is transmitted to the white balance core unit 106 for the correctional operation. The function and processing steps of the white balance core unit 106 are described above and the detailed description of the white balance core unit 106 will not be further described herein.

After the system obtains the correctional color value of the gray pixel, in step 308, the constraint unit 108 may perform a constraint operation on the correctional color value. The white balance core unit 106 only calculates the second mean value and preserves one of the individual values of the color value to correct the color value, if the system has no inspection and repair mechanism, then there is a possibility for each individual value in the correctional color value to have an excessively large difference.

Therefore, when the constraint unit 108 detects the individual values in the correctional color value have excessively large differences, the constraint unit 108 performs a constraint operation on the correctional color value according to the preserving value selected by the white balance core unit 106. The white balance core unit 106 is preserves the medium color value to correct the color value in this embodiment. Hence, when the constraint unit 108 detects individual values in the correctional color value have excessively large differences, the constraint unit 108 preserves the medium color value and revises the maximum color value and the minimum color value to close the medium color value, so that, the correctional color value does not deviate from the white region. In other embodiments, the constraint unit 108 may change the preserving value in the correctional color value according to the value in the original color value preserved by the white balance core unit 106.

In step 312, the white balance system outputs the correctional color value after passing through the constraint unit 108. However, due to some problem caused by the hardware or other unknown reasons, the correctional color value is unpredictable and abnormal and cannot be corrected by the constraint unit 108. Therefore, in the step 310, the limiter unit 108 amends the unpredictable abnormal correctional color value to a predetermined white color value to prevent the output of an unpredictable abnormal correctional color value.

According to the description above, the system decides which gray pixel needs to be corrected by the process range unit 102 and the difference gain unit 104, first. Then the white balance core unit 106 performs the calculation of the mean values and the correctional operation on the color value of the gray pixel. Finally, the constraint unit 108 may perform the constraint operation on the correctional color value. Therefore, the cooperation of these units 102, 104, 106, 108 achieves the object of the white balance correction on the single gray pixel. Moreover, the system contains a limiter unit 110 to prevent the output of an unpredictable abnormal correctional color value.

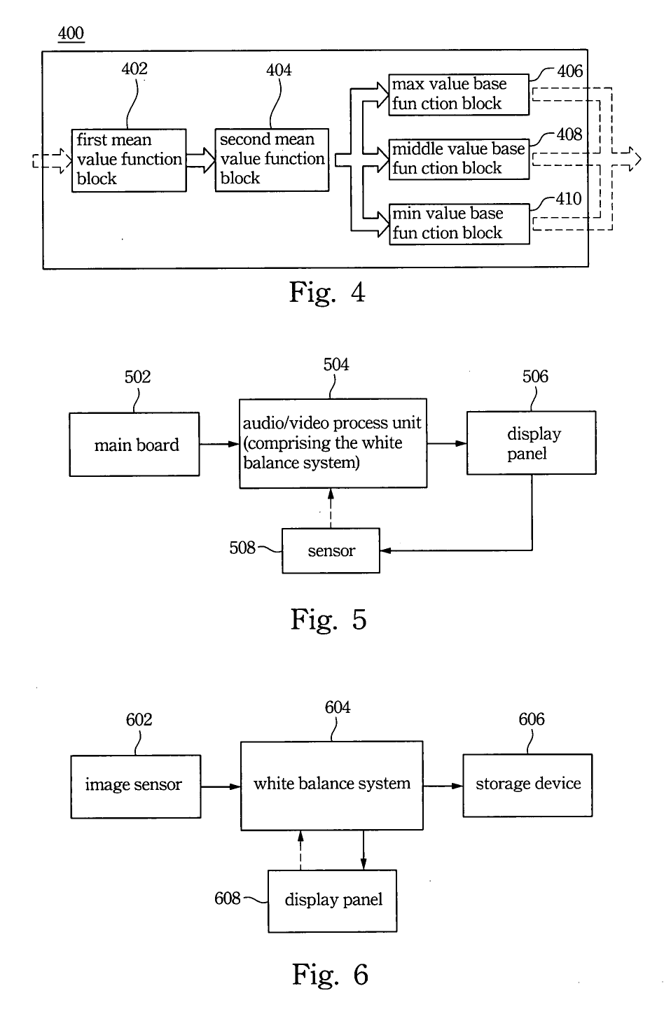

FIG. 4 is a schematic diagram of a core of a white balance system architecture of the embodiment of the present invention. The white balance core unit system architecture 400 contains five parts that include the first mean value function block 402, the second mean value function block 404, the max value vase function block 406, the middle value base function block 408, and the min value base function block 410. When a decision is made to correct a gray pixel, the color value of the gray pixel is processed by the core architecture. The first mean value of the color value is obtained by the first mean value function block 402. Then, the second mean value is obtained by the second mean value function block 404 according to the first mean value. Subsequently, the correctional color value is obtained according to one of the function blocks that are the max value base function block 406, the middle value base function block 408, and the min value base function block 410.

Moreover, the constraint manner of the constraint unit depends on the selection of the function blocks 406, 408, and 410 in the white balance correction. In this embodiment, the white balance system correcting the gray pixel uses the middle value base function block 408 to obtain the correctional color value, therefore, to prevent the situation where each individual value in the correctional color value has an excessively large difference, the constraint unit also performs the correctional operation with preserving the medium color value.

Hence, the kernel of the white balance system is composed of the white balance core unit and the constraint unit. To achieve the object of the auto white balance correction, the kernel of the white balance system further cooperates with the process range unit and the difference gain unit to select the gray pixel. Furthermore, the system contains the limiter unit to correct the unpredictable abnormal correctional color value.

The system performs the white balance correction with a single gray pixel. The gray pixel is selected from the digital image by the process range unit and the difference gain unit. In the embodiment of the present invention, the gray pixels indicate the approximate white color range in the digital image, and the system corrects the gray pixels one pixel at a time. Therefore, the system consumes less of the memory and the register. The core algorithm is very simple and easy to program in the IC chip and software. Due to some advantages described above, the white balance system in the embodiment is suitable for a display device, such as the LCD, PDP etc.

Please refer to FIG. 5. FIG. 5 is a schematic diagram of applying the white balance system of the embodiments of the present invention to a display apparatus. The system includes a main board 502, an audio/video processing unit 504, a display panel 506, and a sensor 508 in the figure. Wherein, the audio/video processing unit 504 comprises the white balance system described in the embodiment of the invention. The main board 502 transmits the digital image signal to the audio/video processing unit 504 for processing. The white balance system also processes the white area of the digital image at the same time, then the audio/video processing unit 504 outputs the processed digital image to the display panel 506. The sensor 508 detects the output pixels of the digital image, and adjusts the processing parameters of the audio/video processing unit 504 dynamically.

Moreover, the system of the embodiment of the invention could apply to the digital video camera or digital camera for an optional white balance mode. FIG. 6 is a schematic diagram showing this kind of application. The system has an image sensor 602, a white balance process system 604, a storage device 606, and a display panel 608. The image sensor 602 is capable of capturing the image. The white balance process system 604 is capable of correcting the digital image and outputting the corrected digital image for the display panel 608. The users could adjust the parameters of the white balance system according to the scene displayed from the display panel 608, and save the digital image on the storage device 606.

The white balance system of the embodiment of the invention could be designed as a program and be developed with software or firmware. Also, the white balance system could be designed as a circuit and developed in a hardware IC chip or integrated with another chip. Moreover, the application of the system further comprises the color adjustment of the prints or scanners.

In view of the foregoing, the system of the embodiment of the present invention directly processes the color value in the RGB domain; therefore, it could reduce the storage and time of the domain conversion and process the white balance of the digital image directly. Of course, to raise the application range, the image in the YUV domain or other color domain could convert to the RGB domain first, then process the image using the white balance system.

Moreover, the system of the embodiment of the invention is a forward only process. If the pixel is decided as a gray pixel to be processed, then the single gray pixel is processed, and the processed single gray pixel is outputted from the system immediately. Therefore, the usage of the memory and the register is very small.

In addition, the core algorithm is very simple and the calculation of the algorithm is small and easy. Therefore, according to the advantages of the low usage of the memory and the register and the simple algorithm, the system consumes less chip area when developed in the hardware circuit. Moreover, the system is very easy to design in a program and realized in software and firmware.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A white balance system for processing a digital image comprises:
a process range unit, capable of selecting at least one pixel from the digital image;
a difference gain unit, capable of determining at least one gray pixel from the pixels needed to be corrected;
a white balance core unit, capable of processing a color value of the gray pixel, and obtaining a correctional color value of the gray pixel; and
a constraint unit, capable of performing a constraint operation on the correctional color value.

2. The system of claim 1, wherein the core of white balance unit calculates a first mean value according to the color value, and obtaining three differences between the maximum color value, the medium color value, the minimum color value and the first mean value, then averaging out these three differences to obtain a second mean value, and performing a correctional operation on the second mean value with the original color value to obtain the correctional color value.

3. The system of claim 2, wherein the correctional operation is capable of preserving the medium color value, and processing the maximum color value and the minimum color value with the second mean value separately.

4. The system of claim 2, wherein the correctional operation is capable of preserving the minimum color value, and processing the maximum color value and the medium color value with the second mean value separately.

5. The system of claim 2, wherein the correctional operation is capable of preserving the maximum color value, and processing the medium color value and minimum color value with the second mean value separately.

6. The system of claim 1, wherein the constraint operation is capable of processing the maximum correctional color value and the minimum correctional color value based on the medium correctional color value.

7. The system of claim 1, wherein the constraint operation is capable of processing the maximum correctional color value and the medium correctional color value base on the minimum correctional color value.

8. The system of claim 1, wherein the constraint operation is capable of processing the medium correctional color value and the minimum correctional color value based on the maximum correctional color value.

9. The system of claim 1, wherein the process range unit, the difference gain unit, and the constraint unit can be set in an off-state or in an on-state separately, the process range unit has a plurality of selecting modes in the on-state, the difference gain unit has a plurality of determining modes in the on-state, and the constraint unit has a plurality of constraint modes in the on-state.

10. The system of claim 1, further comprising a limiter unit capable of emending the correctional color value, wherein the limiter unit can be set in an off-state or in an on-state, and the limiter unit having a plurality of emending modes in the on-state.

11. A white balance method for processing a digital image, comprising the steps of:
selecting a first pixel from the digital image and determining whether the first pixel is a gray pixel or not;
processing the color value of the gray pixel to obtain a first mean value;
obtaining three differences between the maximum color value, the medium color value, the minimum color value and the first mean value, and averaging out these three differences to obtain a second mean value; and
performing a correctional operation on the color value with the second mean value to obtain a correctional color value of the gray pixel.

12. The method of claim 11, wherein the step of performing the correctional operation is that preserving the medium color value, and processing the maximum color value and the minimum color value with the second mean value separately.

13. The method of claim 11, wherein the step of performing the correctional operation is that preserving the minimum color value, and processing the maximum color value and the medium color value with the second mean value separately.

14. The method of claim 11, wherein the step of performing the correctional operation is that preserving the maximum color value, and processing the medium color value and the minimum color value with the second mean value.

15. The method of claim 11, wherein the step of performing the correctional operation on the color value with the second mean value to obtain a correctional color value of the gray pixel further comprises the step of:
performing a constraint operation on the correctional color value.

16. The method of claim 15, wherein the step of performing the constraint operation on the correctional color value is that processing the maximum correctional color value and the minimum correctional color value based on the medium correctional color value.

17. The method of claim 15, wherein the step of performing the constraint operation on the correction color value is that processing the maximum correctional color value and the medium correctional color value base on the minimum correctional color value.

18. The method of claim 15, wherein the step of performing the constraint operation on the correction color value is that processing the medium correctional color value and the minimum correctional color value based on the maximum correctional color value.

19. The method of claim 15, wherein after executing the step of performing the constraint operation on the correctional color value further comprises the step of:
emending the correctional color value to a predetermined color value.

20. A white balance system for processing a digital image comprises:
a white balance core unit, capable of processing a color value of at least one gray pixel, and obtaining a correctional color value of the gray pixel, wherein the core of the white balance unit further comprises:
a first mean value function block, capable of obtaining a first mean value from the color value;
a second mean value function block, capable of obtaining three differences between the maximum color value, the medium color value, the minimum color value and the first mean value, the averaging out these three differences to obtain a second mean value;
a max value based function block, capable of preserving the maximum color value, and processing the medium color value and the minimum color value with the second mean value separately;
a middle value base function block, capable of preserving the medium color value, and processing the maximum color value and minimum color value with the second mean value separately;
a minimum value base function block, capable of preserving the minimum color value, and processing the maximum color value and medium color value with the second mean value separately;
wherein the correctional color value is obtained by one of the max value base function block, the middle value base function block, and the min value base function block; and
a constraint unit, capable of performing a constraint operation on the correctional color value.

21. The system of claim 20, wherein the constraint operation performed by the constraint unit corresponds to the function block used to obtain the correctional color value, the constraint unit can be set in an off-state or in an on-state, and the constraint unit has a plurality of constraint modes in the on-state.

22. The system of claim 20, further comprising a process range unit capable of selecting at least one first pixel from the digital image, wherein the process range unit can be set in an off-state or in an on-state, and the process range unit has a plurality of selecting modes in the on-state.

23. The system of claim 22, further comprising a difference gain unit capable of determining whether the first pixels are the gray pixel or not, wherein the difference gain unit can be set in an off-state or in an on-state, and the difference gain unit has a plurality of determining modes in the on-state.

24. The system of claim 20, further comprising a limiter unit capable of emending the correctional color value, wherein the limiter unit can be set in an off-state or in an on-state, and the limiter unit has a plurality of correcting modes in the on-state.

25. The system of claim 20, further comprising a difference gain unit capable of determining whether the first pixels are the gray pixel or not, wherein the difference gain unit can be set in an off-state or in an on-state, and the difference gain unit has a plurality of selecting modes in the on-state.
